(19) United States
(12) Patent Application Publication
(10) Pub. No.: US 2008/0289394 A1
(43) Pub. Date: Nov. 27, 2008

(54) Compression jaw set with failure mode preventing reuse

(75) Inventor: Brian A. Mitchell, Olmsted Falls, OH (US)

Correspondence Address: RANKIN, HILL & CLARK LLP, 38210 Glenn Avenue, WILLOUGHBY, OH, 44094-7808, US

(73) Assignee: Emerson Electric Co.

(21) Appl. No.: 11/805,600

(22) Filed: May 23, 2007

(51) Int. Cl. B25B 27/02

(52) U.S. Cl. 72/409.1; 72/467

(57) ABSTRACT

A jaw arm for an associated compression tool having cam rollers that displace forwardly and rearwardly along an axis to pivot the jaw arm includes a recess and a notch. The recess is disposed adjacent a forward end of the jaw arm. The notch is axially spaced rearwardly from the recess. The recess is configured to receive an associated pipe and an associated coupling for compressing at least one of the associated pipe and the associated coupling to mechanically attach the associated pipe to the associated coupling when the jaw arm is pivotally displaced toward at least one of the associated pipe and the associated coupling. The notch is configured to receive an associated cam roller of the associated compression tool and to retain the associated cam roller to inhibit axial rearward movement of the associated cam roller when the associated cam roller has been received in the notch. A pressing tool and a jaw set incorporating the aforementioned jaw arm is also disclosed.

### BACKGROUND

Compression tools for joining tubes or pipes and coupling components typically include a compression jaw set removably mounted on a drive mechanism. The jaw arms of the set are displaced into compression about a pipe and coupling to mechanically join the two.

At some point during the life of the jaw set, failure will occur. A jaw arm can crack, thus leaving it incapable of exerting the required force to adequately join a coupling to a pipe. Accordingly, it is desirable to deter one from continuing to use a jaw arm having a crack, especially a crack that is difficult to detect through perfunctory visual inspection.

### BRIEF SUMMARY OF THE INVENTION

A jaw arm for an associated compression tool having cam rollers that displace forwardly and rearwardly along an axis to pivot the jaw arm includes a recess and a notch. The recess is disposed adjacent a forward end of the jaw arm. The notch is axially spaced rearwardly from the recess. The recess is configured to receive an associated pipe and an associated coupling for compressing at least one of the associated pipe and the associated coupling to mechanically attach the associated pipe to the associated coupling when the jaw arm is pivotally displaced toward at least one of the associated pipe and the associated coupling. The notch is configured to receive an associated cam roller of the associated compression tool and to retain the associated cam roller to inhibit axial rearward movement of the associated cam roller when the associated cam roller has been received in the notch.

A compression tool includes a connection unit, cam rollers, and jaw arms. The cam rollers mount for axially movement forwardly and rearwardly with respect to the connection unit. Each jaw arm is similar to the jaw arm described above.

A jaw set for an associated compression tool having cam rollers includes a first plate, a second plate spaced from the first plate, and a pair of jaw arms pivotally mounted between the plates. Each jaw arm can be similar to the jaw arm described above.

### BRIEF DESCRIPTION OF THE DRAWINGS

The drawings are only for purposes of illustrating embodiments of the invention and are not to be construed as limiting the invention, which is defined by the appended claims.

FIG. 1 is a perspective view of a pressing tool and a jaw set connected to the pressing tool.

FIGS. 2-4 are schematic cross-sectional views of the jaw set and rollers of the pressing tool contacting the jaw set at different stages or operating positions.

FIG. 2 shows the cam rollers in a retracted position.

FIG. 3 shows the cam rollers in a first extended position.

FIG. 4 shows the cam rollers in a second extended position.

FIG. 5 is an alternative embodiment of a jaw arm for the jaw set for the pressing tool depicted in FIG. 1.

FIG. 6 is a hydraulic diagram depicting hydraulic components found in the pressing tool depicted in FIG. 1.

### DETAILED DESCRIPTION OF THE INVENTION

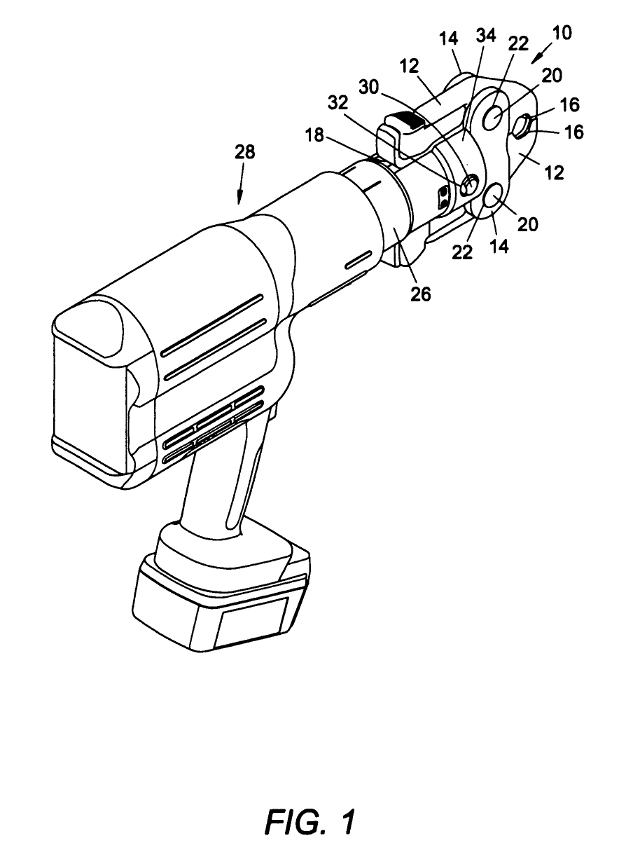

With reference to FIG. 1, the jaw set 10 includes a pair of jaw arms 12 pivotally mounted between a pair of side plates 14. Each jaw arm includes a jaw recess 16 at one end and an inwardly facing cam surface 18 at the opposite end. The recesses 16 oppose one another to receive a pipe and coupling (not shown in FIG. 1).

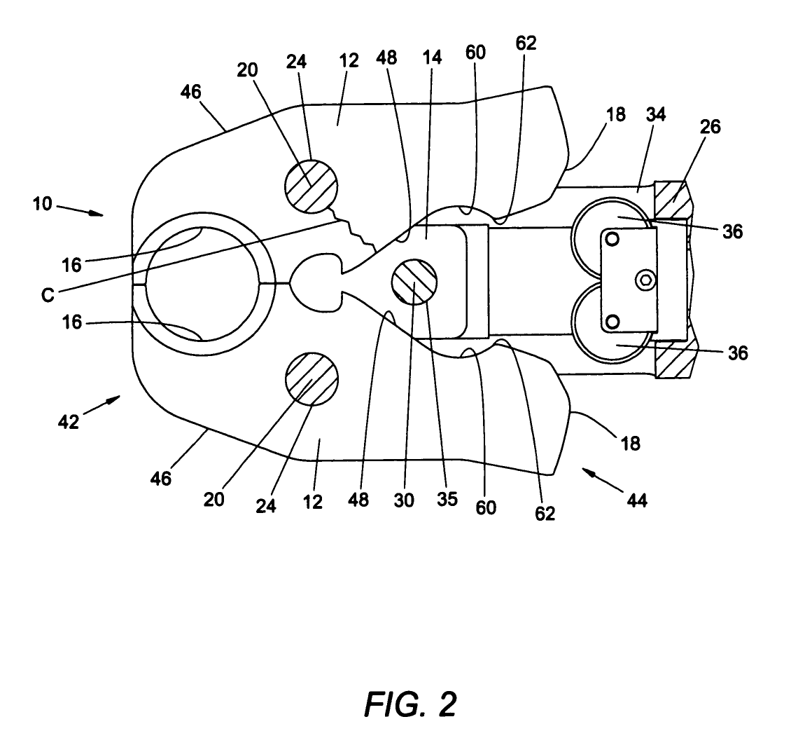

Each jaw arm 12 is pivotal about a respective pin 20 located in respective openings 22 in the side plates 14 and through openings 24 (FIGS. 2-4) in the jaw arms 12 between the opposite ends thereof. The jaw set 10 mounts on a connection unit, which in the depicted embodiment is a hydraulic cylinder head 26, of a pressing tool 28 by a pin 30 that extends through aligned openings 32 in holding arms 34 found on the cylinder head and aligned openings 35 (only one visible in FIGS. 2-4) found in each of the side plates 14. The mounting pin 30 is disposed at a location relative to the jaw set 10 which is laterally between the respective pivot pins 20 and between the pivot pins and respective cam surfaces 18 of the jaw arms 12.

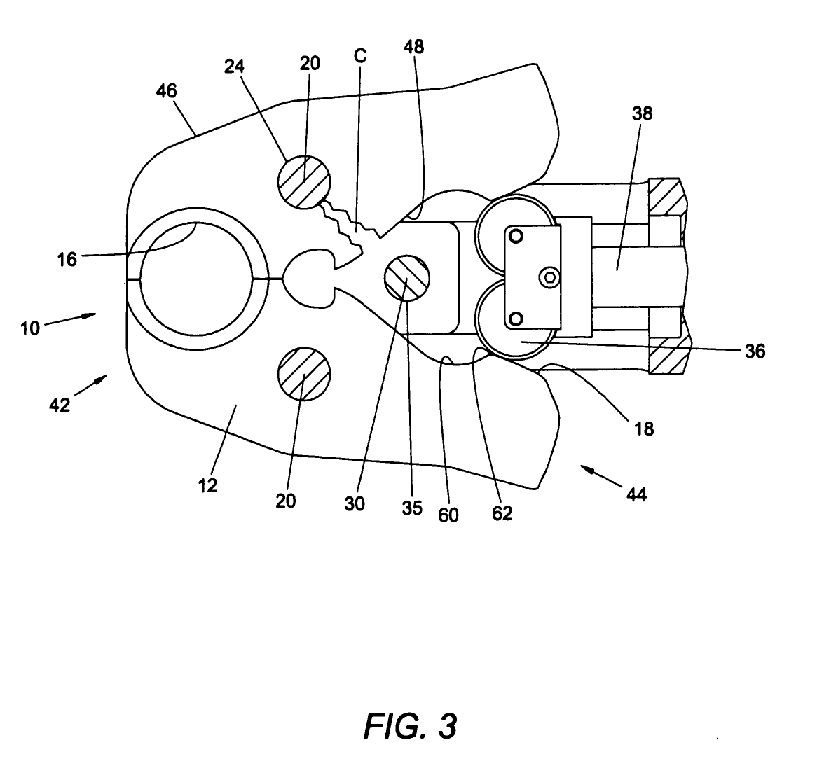

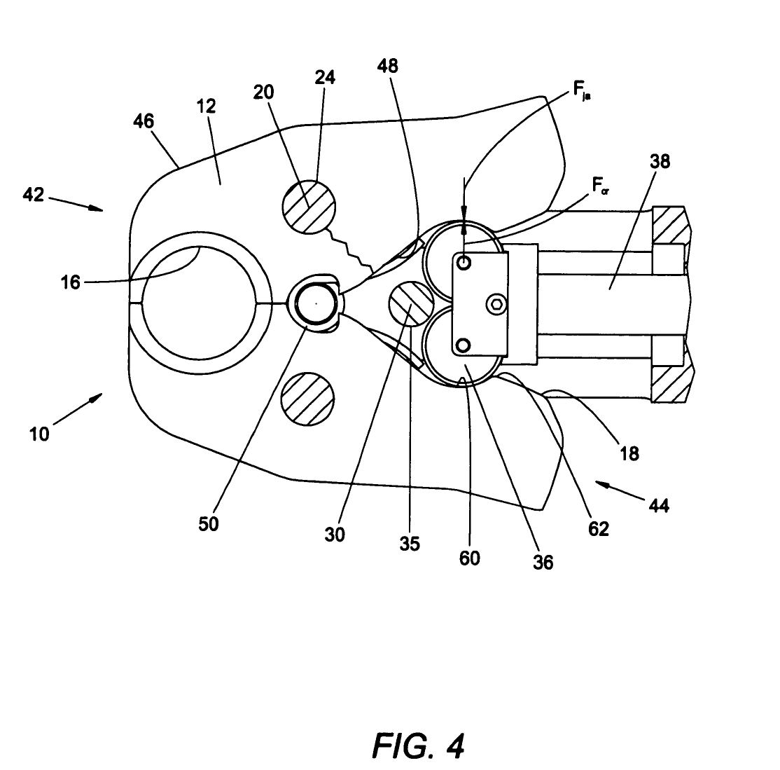

The pressing tool includes cam rollers 36 (FIGS. 2-4) connected to a piston 38 (FIGS. 3 and 4) that are displaceable axially forwardly and rearwardly along the cam surfaces 18 of the jaw arms 12. When displaced forwardly on the cam surfaces 18, the cam rollers 36, engage the cam surfaces and displace the opposed jaw recesses 16 toward one another and constrictably about a pipe and coupling interposed therebetween. The piston 38 is hydraulically operated in the depicted embodiment.

Each jaw arm 12 has longitudinally opposite front and rear ends 42 and 44, respectively. Each jaw arm 12 further includes laterally outer and inner edges 46 and 48, respectively, which are spaced from pivot pin opening 24 and which extend forwardly and rearwardly of the opening. The inner edges 48 of the jaw arms provide laterally the inwardly open opposed jaw recesses 16 near the respective front ends 42 and forwardly of side plates 14 and laterally inwardly facing cam surfaces 18 near the rear ends 44. The inner edges 48, laterally inwardly of pin openings 20, also receive and support a hairpin-shaped spring 50 (only depicted in FIG. 4 for clarity) biases jaw arms 12 in opposite directions about pins 20 to bias jaw recesses 16 laterally inwardly toward one another.

In use, the jaw set 10 is mounted on the cylinder head 26 of the pressing tool 28 in a well-known manner by means of the pin 30 which is attached to the pressing tool and received in the side plate openings 32, as discussed above. Rear ends 44 of the jaw arms 12 are then manually displaced toward one another to pivot the jaw arms about pins 20 against the bias of the spring 50 to open the jaw recesses 16 to receive a pipe and coupling to be compressed. Upon release of the jaw arms 12, the spring 50 closes the jaw recesses 16 about the pipe and coupling. The pressing tool 26 is then actuated for the cam rollers 36 thereon to advance axially forwardly toward the jaw set 10 and simultaneously engage against the cam surfaces 18 to displace jaw arms 12 about the pins 20 for the jaw recesses 16 to compress the pipe and coupling together. Thereafter, the pressing tool 26 is actuated to retract the cam rollers 36, and the jaw arms 12 are again manually displaced against the bias of the spring to open the jaw recesses 16 for removal of the jaw set 10 from the compressed pipe and coupling.

With reference to FIGS. 2-4, the jaw arms 12 can crack, depicted as crack C. The crack C is shown beginning at the inner surface 46 and terminating at the pin opening 24; however, the crack not always terminates at the pin opening. Once a jaw arm 12 cracks, it is likely that the jaw arms 12 no longer can provide adequate crimping force to join a coupling to a pipe to make a water-tight connection. Accordingly, it is useful to provide a signal to the operator of the tool that the jaw set 10 has failed and needs to be replaced.

To provide such a signal, each jaw set includes a notch 60 that is configured to receive a respective cam roller 36 and to retain the cam roller to inhibit the cam roller from retracting back into the tool after the jaw arm 12 has cracked, or failed.

With reference to FIGS. 2-4, FIG. 2 depicts the cam rollers 36 axially approaching respective cam surfaces 18 of the jaw arms 12. The cam surfaces 18 are gradually inclined toward a central axis (the axis that is parallel to the direction in which the rollers extend and retract). FIG. 3 depicts the rollers 36 traveling along the respective cam surfaces 18 thus pivoting the jaw arms 12 about pivot pins 20. FIG. 3 depicts the crack C growing larger, whereby the upper jaw arm 12 exhibits a greater amount of flexure than the lower jaw arm, as the rollers 36 advance forwardly along the cam surfaces 18. The cam surfaces 18 terminate at a forward end at a point of inflection 62 which leads to the notch 60 traveling along the inner surface 48 in a forward direction. The point of inflection 62 serves as a transition between the notch 60 and the cam surface 18. The cam surface 18 is long enough in a generally axial direction to allow the cam roller 36 to travel along the cam surface to pivot the jaw arm 12 and to compress at least one of a pipe and a coupling to mechanically attach the pipe to the coupling without the cam roller extending into the notch when the jaw arm 12 does not experience a crack or greater than a predetermined flexure. The cam surface 18 is also short enough in an actual direction to allow the cam roller 36 to travel along the cam surface and enter into the notch 60 when the jaw experiences greater than a predetermined flexure or a crack (see FIG. 4). Accordingly, FIG. 3 depicts the cam rollers 36 in a first extended position, which is the position that the cam rollers 36 would typically extend to when joining a coupling to a pipe. Typically the jaw arms 12 will not crack nor flex beyond a predetermined flexure, and therefore the piston 38 would drive the rollers 36 to a first extended position generally around a location shown in FIG. 3.

When one or both of the jaw arms 12 experience a crack C, however, the rollers 36 move into a second extended position, which is forwardly beyond the first extended position. It is in this second extended position that the rollers 36 ride over the point of inflection 62 and into the notch 60. As seen by comparing FIG. 3 to the FIG. 4, the crack C may widen as the rollers 36 advance along the cam surface 18 until the rollers cross the point of inflection 62 and fall into the notch 60 whereby the jaw arm flexes laterally back towards the central axis thus trapping the respective roller 36 and the respective notch 60.

The jaw arm 12 and the notch 60 are configured in a manner to allow the jaw arm to generate a moment force (the moment arm being generally defined between the pivot pin 20 and the point of inflection 62, which is the transition between the notch 60 and the cam surface 18) that is greater than an oppositely directed force (a force directed perpendicular to the central axis) from the cam roller when the cam roller attempts to move rearwardly out of the notch. Accordingly, the jaw arm 12 can be made from an appropriate material to provide this moment force and the notch can be appropriately configured so that a great enough moment force can be applied to the cam rollers. Since the crack C can extend from the inner surface 48 towards the opening 22 for the pivot pin 20 (a stress concentrator, which will be described below, can be provided to facilitate the formation of this crack) a sufficient amount of material for the jaw arm 12 can be provided around the opening 22 to generate the sufficient moment force adjacent the transition (the point of inflection 62) of the notch and the cam surface. The amount of material provided along the outer circumference of the pivot pin opening 24 is a function of the material from which the jaw arm 12 is made as well as the required moment force to retain the cam roller.

The notch 60 depicted in FIGS. 2-4 is generally curved in a concave manner and includes a portion that follows the radius of the cam rollers (see FIG. 4) for at least about 45 degrees or π/4 radians of the cam roller's circumference. The portion of the notch 60 that follows the radius of cam rollers 36 is generally rearwardly disposed in the notch, which provides a longer contact surface against which the roller 36 acts when the piston 38 is attempted to be moved axially rearwardly in an attempt to remove the rollers 36 from the notch.

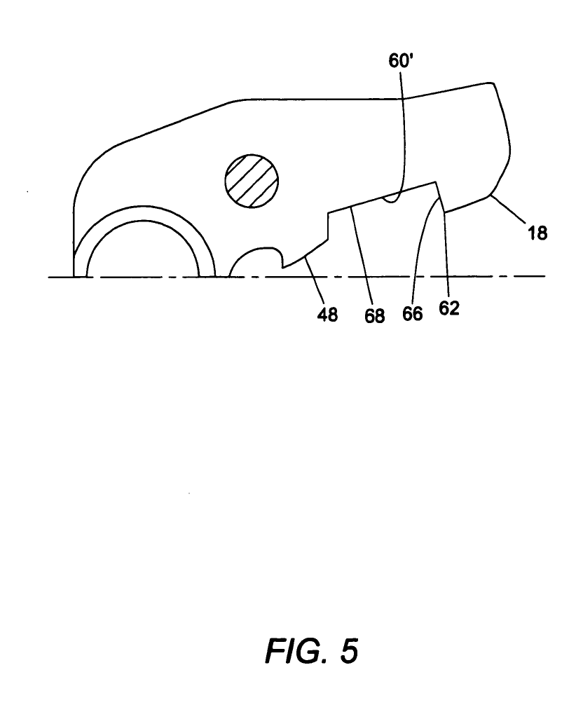

The notch 60 can take alternative configurations; however, it is generally considered desirable to provide a point of inflection at the transition between the cam surface and the notch 60 to increase the difficulty of removing the cams 36 from the respective notches 60. With reference to FIG. 5, a notch 60′ is shown having an alternative configuration that includes a planar rearward edge 66. A point of inflection 62 exists at the transition between the cam surface 18 and the notch 60. The notch 60′ provides a sharp drop off to fit the cam roller 36 at the second extended position of the roller travel. The notch 60′ can extend outward from the inner surface 48 a depth greater than a radius of the cam roller that the notch is configured to receive. The rearward edge 66 can be perpendicular to an innermost planar edge 68 of the notch, (and a direction in which the cam rollers 34, 36 move) at an acute angle to the innermost planar edge or at an obtuse angle to the innermost planar edge.

As discussed above, it has been found desirable to provide a clear signal to the operator that the jaw set has become unusable. Preventing the retraction of the cam rollers can provide such a signal. Accordingly, the notch as described above not allowing the piston 38 and the cam rollers 36 to retract can provide such a signal to the operator of the pressing tool.

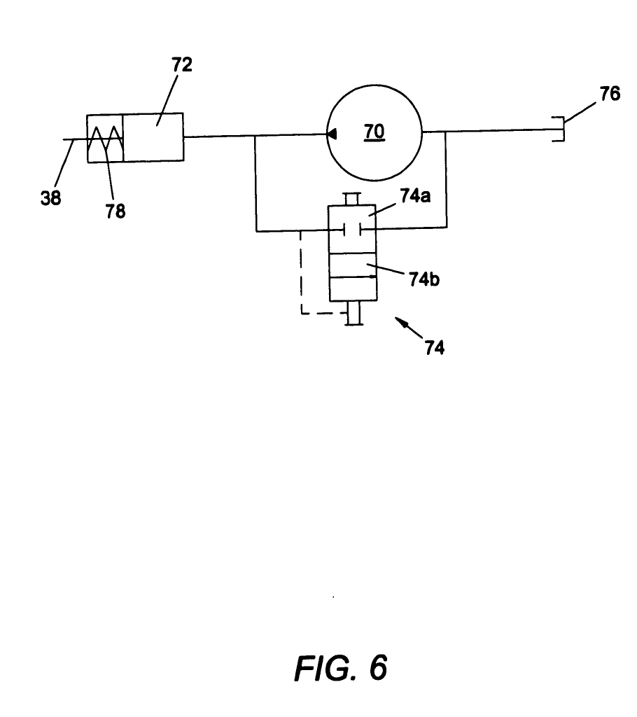

With reference to FIG. 6, a schematic depiction of a hydraulic system found in the pressing tool 26 is disclosed. A hydraulic pump 70 delivers fluid under pressure to a cylinder 72 where the piston 38 to which the cam rollers 36 (FIGS. 2-4) are connected is found. The hydraulic system includes a valve 74. When the valve 74 is in a first position 74a fluid is delivered from tank 76, which in the depicted pressing tool is a rubber bladder, into the cylinder 72. This first position of the valve 74a results in the piston 38 extending from the cylinder 72, which results in the cam rollers 36 moving forward axially along the cam surfaces 18 of the jaw arms 12. The valve 74 also includes a second position 74b which connects the cylinder 72 directly to tank 76 bypassing the pump 70. While in this position, a spring 78 biases the piston 38 rearward towards a retracted position and fluid moves from the cylinder 72 through the valve 74 into tank 76.

When the piston 38 is being extended, the hydraulic pressure on the opposite side of the piston 38 as the spring 78 overcomes the biasing force of the spring which allows the cam rollers 36 to move forward towards the cam surfaces 18 of the jaw arms 12. When the pressure in the hydraulic cylinder 72 exceeds a threshold value, the valve 74 moves into the second operating position 74b, at which time the biasing force of the spring 78 biases the piston 38 to the right in FIG. 6 whereby fluid passes from the cylinder 72 into tank 76.

With reference back to FIG. 4, the cam rollers 36 are shown disposed in respective notches 60. Because of the material from which each jaw arm 12 is made and the configuration of the notch 60, a force Fⱼₐ is applied in a direction normal to the central axis thus retaining the cam roller 36 in the notch 60. The cam roller 36 exerts a force F_{cr} in an opposite direction as the jaw arm force Fⱼₐ. The cam roller force F_{cr} is related to the biasing force of the spring 78 (FIG. 6) attempting to retract the piston 38. The jaw arm force Fⱼₐ is a function of the material and the lever arm of the moment, which is roughly the distance between the transition 62 of the notch 60 to the cam surface 18 and the pivot axis (generally the center point of pivot pin 20) of the jaw arm 12. The biasing force of the spring 78 is enough to retract the piston 38 into the cylinder head 26 (FIG. 1) when the cam rollers 36 do not cross the point of inflection 62; however, when the cam rollers 36 cross the point of inflection and become seated in the notch 60, the biasing force of the spring 78 is not great enough to overcome the force of the jaw arm Fⱼₐ.

A jaw arm, a jaw arm set and a pressing tool have been described with reference to particular embodiments. Modifications and alterations will occur to those upon reading and understanding the preceding detailed description. The preceding detailed description is intended to include all such modifications and alterations that would occur to those who are skilled in the art.

1. A jaw arm for an associated compression tool having cam rollers that displace forwardly and rearwardly along an axis to pivot the jaw arm, the jaw arm comprising a recess disposed adjacent a forward end of the jaw arm and a notch axially spaced rearwardly from the recess, the recess being configured to receive an associated pipe and an associated coupling and for compressing at least one of the associated pipe and the associated coupling to mechanically attach the associated pipe to the associated coupling when the jaw arm is pivotally displaced toward at least one of the associated pipe and the associated coupling, the notch being configured to receive an associated cam roller of the associated compression tool and to retain the associated cam roller to inhibit axial rearward movement of the associated cam roller when the associated cam roller has been received in the notch.

2. The jaw arm of claim 1, wherein the notch includes a surface having a portion that that follows a radius R for at least about π/4 radians.

3. The jaw arm of claim 1, wherein the notch includes a planar surface extending into the jaw arm.

4. The jaw arm of claim 3, wherein the planar surface is disposed at a rearward end of the notch.

5. The jaw arm of claim 1, wherein the notch includes a concave surface.

6. The jaw arm of claim 1 further comprising an opening therethrough for receiving a pin to connect the jaw arm with the associated compression tool and a stress concentrator along an inner edge for initiating a fatigue crack toward the opening.

7. A compression tool comprising:
a connection unit;
cam rollers mounted for axial movement forwardly and rearwardly with respect to the connection unit; and
jaw arms each pivotally connected with the connection unit, each jaw arm comprising a recess and a notch axially spaced from the recess, the recess being configured to receive an associated pipe and an associated coupling for compressing at least one of the associated pipe and the associated coupling to mechanically attach the associated pipe to the associated coupling when the jaw arm is displaced toward at least one of the associated pipe and the associated coupling, the notch being configured to receive a respective cam roller and to retain the cam roller to inhibit axial movement of the cam roller once the cam roller has been received in the notch.

8. The tool of claim 7, wherein the cam rollers move between a retracted position and a first extended position, the first extended position being the forwardmost position for the cam rollers when each of the jaw arms experiences less than a predetermined flexure.

9. The tool of claim 8, wherein the cam rollers move to a second extended position that is axially forward the first extended position when at least one of the jaw arms experiences greater than a predetermined flexure.

10. The tool of claim 7, further comprising a piston, a hydraulic cylinder and a spring providing a biasing force to bias the piston toward a retracted position, the cam rollers being connected to the piston and movable toward an extended position when pressurized fluid is delivered to the hydraulic cylinder to overcome the biasing force of the spring, the jaw arm being made from and including a sufficient amount of material for generating a locking force on the cam roller when the cam roller is received in the notch, the biasing force of the spring being incapable of generating a force in the cam roller to overcome the locking force.

11. The tool of claim 7, wherein each jaw arm includes a surface having a portion that that follows a radius that is substantially equal to the radius of the respective cam roller that is received in the notch.

12. The tool of claim 7, wherein each jaw arm includes a planar surface disposed at a rearward end of the notch.

13. The tool of claim 12, the planar surface extends into the jaw arm generally perpendicular to the direction in which the cam rollers move.

14. The tool of claim 13, wherein the planar surface extends laterally outward a depth greater than a radius of the cam roller that the notch is configured to receive.

15. The tool of claim 7, wherein each jaw arm includes a cam surface disposed on an axially rearward side of the notch, the cam surface defining a length to allow the respective cam roller to travel along the cam surface to pivot the jaw arm and to compress at least one of the associated pipe and the associated coupling to mechanically attach the associated pipe to the associated coupling without the cam roller entering into the notch when the jaw arm experiences less than a predetermined flexure.

16. The tool of claim 15, wherein the cam surface defining a length to allow the cam roller to travel along the cam surface and enter into the notch when the jaw arm experiences greater than the predetermined flexure.

17. The tool of claim 10, wherein each jaw arm includes an opening therethrough for receiving a pin to pivotally attach the jaw arm to the connection unit, the jaw arm and the notch being configured to allow the jaw arm to generate a moment force adjacent a transition of the notch and the cam surface that is greater than an oppositely directed force from the cam roller when the cam roller attempts to move rearwardly out of the notch.

18. The tool of claim 17, wherein the jaw arm includes a stress concentrator along an inner edge and is made from and includes a sufficient amount of material around the opening to generate a moment force adjacent a transition of the notch and the cam surface that is greater than an oppositely directed force from the cam roller when the cam roller attempts to move rearwardly out of the notch.

19. A jaw set for an associated compression tool having cam rollers, the jaw set comprising:
a first plate;
a second plate spaced from the first plate in a first direction;
a pair of jaw arms pivotally mounted between the plates, each jaw arm including a recess, a notch spaced from the recess in a second direction that is generally perpendicular to the first direction and a cam surface spaced from the notch in the second direction, the recess being configured to receive an associated pipe and an associated coupling for compressing at least one of the associated pipe and the associated coupling to mechanically attach the associated pipe to the associated coupling when the jaw arm is displaced toward at least one of the associated pipe and the associated coupling, the notch being configured to receive an associated cam roller of the associated compression tool and to retain the associated cam roller to inhibit axial movement of the associated cam roller once the cam roller has been received in the notch.

20. The jaw set of claim 19, wherein each jaw arm includes an opening therethrough for receiving a pin to connect the jaw arm with the associated compression tool and a stress concentrator along an inner edge for initiating a fatigue crack toward the opening, each jaw arm being made from and including a sufficient amount of material around the opening to generate a moment force adjacent a transition of the notch and the cam surface that is greater than an oppositely directed force from the cam roller when the cam roller attempts to move rearwardly out of the notch.
